(19) United States
(12) Patent Application Publication
(10) Pub. No.: US 2023/0194013 A1
(43) Pub. Date: Jun. 22, 2023

(54) FLUIDIC COMPONENT AND DEVICE OF FLUIDIC VALVE TYPE FOR ISOLATION

(71) Applicant: Commissariat à l'Energie Atomique et aux Energies Alternatives, Paris (FR)

(72) Inventors: Guillaume BLAIRE, Grenoble Cedex 9 (FR); Manuel ALESSIO, Grenoble Cedex 9 (FR); Mélissa BAQUE, Grenoble Cedex 9 (FR); Jean-Maxime ROUX, Grenoble Cedex 9 (FR)

(73) Assignee: Commissariat à l'Energie Atomique et aux Energies Alternatives, Paris (FR)

(21) Appl. No.: 18/064,981

(22) Filed: Dec. 13, 2022

(30) Foreign Application Priority Data
Dec. 17, 2021 (FR) 21 13755

(51) Int. Cl. F16K 31/00; F16K 31/126; B01L 3/00; B01L 7/00

(52) U.S. Cl. CPC F16K 31/002; F16K 31/1266; B01L 3/502738; B01L 3/50273; B01L 7/525; B01L 2300/1827; B01L 2300/123; B01L 2300/14; B01L 2200/08; B01L 2400/0633; B01L 2300/049; B01L 2200/027

(57) ABSTRACT

A fluidic component intended to be associated with a heating module and wherein there is created a fluidic circuit which includes an inlet channel and an outlet channel, the fluidic component including a fluidic valve mechanism including: a fluidtight reservoir intended to be filled with a volume of gas capable of expanding, a deformable membrane closing the reservoir in a fluidtight manner, the membrane being able to deform by expansion of the volume of gas, between a first position wherein it forms a passage between the inlet channel and the outlet channel so as to allow a fluid to pass, and a second position wherein it obstructs the passage.

### TECHNICAL FIELD OF THE INVENTION

The present invention relates to a fluidic component and to a device of fluidic valve type. The device may notably comprise a reaction chamber, that can be isolated by a fluidic valve mechanism. The invention also relates to an analysis method implemented in said device.

### PRIOR ART

Microfluidic devices formed of a microfluidic network of microfluidic capsules and of channels connecting the capsules to one another are known from documents US2012/064597A1, US2013/130262A1, US2007/166199A1 and US2006/076068A1. Each microfluidic capsule comprises a chamber into which an inlet channel opens and from which an outlet channel emerges. A deformable membrane is commanded between two positions to confer two distinct states on the capsule: a first state in which the inlet channel communicates with the outlet channel via the chamber, allowing a transfer of fluid, and a second state in which the membrane blocks the communication between the two channels, preventing the flow of fluid and preventing the filling of the chamber of the capsule. The membrane is commanded between its two states using pneumatic means, for example by applying a positive pressure or negative pressure to it.

In order to produce these devices, the known solutions are performed using a multilayer assembly in which the deformable membrane forms an intermediate layer sandwiched between two substrates. The membrane is often bonded, clamped between two layers, or fixed using a pre-cut double-sided sticky tape. In these documents, the microfluidic capsules are incorporated into microfluidic cards or cartridges which have pneumatic connectors so that they can be connected to external pressure sources and regulators. One disadvantage with these solutions is the need to provide a leak-free air or fluid connection between the microfluidic card incorporating the capsules and the pressure sources. Another disadvantage is the noise produced by the pumps or compressors generally used as pressure sources.

One alternative to the pumps and compressors is to use a gas cartridge but the pressure produced needs to be regulated and, what is more, the use of such pressure sources may be subject to regulations such as, for example, when being transported by aeroplane.

Patent application EP3326717A1 proposes another solution in which the valve is created by adding to a cavity a liquid that is intended to form an element made of deformable material. The actuating mechanism of the invention is commanded by a command and processing unit to deform the deformable-material element of each capsule, for example by applying a pressure or a pressure pulse by means of a pressurizing fluid, particularly a pressurizing gas, via the actuating holes of each capsule. The command and processing unit is managed by a plurality of software modules, each software module corresponding to one or more of the steps of the method. In this invention, the pressurizing source is not described, but command by a plurality of modules proves to be complex.

These various valve solutions are pneumatically actuated and require complex external means to actuate them. These means generally comprise external pumps or compressors as pressure sources, pressure regulators, and sometimes also electrically-operated valves. These means are external to the microfluidic devices which means that fluidtight pneumatic connections need to be provided. Furthermore, these means need to be commanded and regulated by dedicated mechanisms or else operated by electronic circuits and possibly software.

It may be advantageous to have a valve mechanism the actuation of which is simple and reliable, without recourse to complex means that need to be operated or regulated.

One attractive solution for integrating a pressure source into the fluidic component has been described using chemical compounds in the referenced publication “Charlotte Parent, Nicolas Verplanck, Jean-Luc Achard, Yves Fouillet. Validation and integration of an effervescent reaction for fluid actuation in a microfluidic device. Micro TAS 2016 Conference, October 2016, Dublin, Ireland”. However, this solution requires the integration of reagents in effectively tailored quantities so as to have a level of pressure that is both workable and does not risk causing damage to the component. Another disadvantage is the recourse to a manipulation in order to test the membrane that initially separates the chemical compounds.

It is therefore still of relevance to acquire the use of a fluidic component incorporating a fluidic valve mechanism, that can be rapidly deployed in the field, using actuating means that are already present and readily available.

It is a first objective of the invention first of all to propose a fluidic component that meets this need.

It is a second objective of the invention to propose a device of fluidic valve type comprising such a fluidic component and having simple and reliable means for actuating the fluidic valve mechanism of the component.

### SUMMARY OF THE INVENTION

This first objective is achieved by a fluidic component intended to be associated with a heating module and in which there is created a fluidic circuit which comprises an inlet channel and an outlet channel, said fluidic component comprising:
A fluidic valve mechanism comprising:
   A fluidtight reservoir intended to be filled with a volume of gas capable of expanding,
   A deformable membrane closing said reservoir in a fluidtight manner, said membrane being able to deform by expansion of said volume of gas, between a first position in which it forms a passage between said inlet channel and said outlet channel so as to allow a fluid to pass, and a second position in which it obstructs said passage.

According to one special feature, the component comprises at least a first substrate in which said inlet channel and said outlet channel are produced, and a second substrate into which there is hollowed a cavity forming said reservoir, facing the inlet channel and the outlet channel, said membrane being interposed between the first substrate and said second substrate in order to cover said cavity.

According to another special feature, the membrane is made from a material of elastomer type.

According to another special feature, the component is produced in the form of a one-piece element incorporating said fluidic circuit and said fluidic valve mechanism.

The second objective is achieved by a device of fluidic valve type comprising:
A fluidic component as defined hereinabove,
A heating module designed to heat said volume of gas contained in said reservoir and commanded to heat it to a temperature sufficient to expand said volume of gas present in the reservoir, causing the membrane to deform from its first position toward its second position.

According to one particular embodiment, said component is produced in the form of a one-piece element able to fit onto a support including said heating module.

According to another particular embodiment, said component is produced in the form of a one-piece element, the heating module being incorporated into said one-piece element.

According to one special feature, the fluidic circuit comprises a reaction chamber, and said fluidic valve mechanism is arranged on the fluidic circuit opening into said reaction chamber, the heating module being designed to heat both:
Said reaction chamber in order to perform a detection reaction, and
The reservoir of said fluidic valve mechanism so as to expand the volume of gas, causing the membrane to move toward its closure position with a view to isolating the chamber during said reaction.

According to another special feature, the heating module comprises two resistive branches in parallel, each one configured to exhibit a distinct electrical resistance, the first resistive branch being dedicated to providing a first thermal power, for example to the reservoir of the fluidic valve mechanism, and the second resistive branch being dedicated to providing a second thermal power, for example to said reaction chamber, said first thermal power being higher than the second thermal power.

According to another special feature, the heating module comprises at least two resistive branches in series, each one configured to exhibit a distinct electrical resistance, the first branch being dedicated to providing a first thermal power and the second branch dedicated to providing a second thermal power distinct from the first thermal power.

The invention also relates to an analysis method implemented in a device as defined hereinabove, the method consisting in activating the heating module to a temperature sufficient to both implement a detection reaction in said reaction chamber and actuate the membrane toward its closure position so as to isolate the reaction chamber during said detection reaction.

It should be noted that splitting the heating module into at least two resistive branches advantageously allows at least two distinct thermal powers to be supplied to the different components of the device, and thus allows the method to be better sequenced.

### BRIEF DESCRIPTION OF THE FIGURES

Other features and advantages will become apparent from the following detailed description, which is given with reference to the appended drawings, in which:

FIG. 1 depicts the device of fluidic valve type of the invention, viewed from above.

FIG. 2 illustrates the principle of operation of the device of fluidic valve type of the invention, with its fluidic valve mechanism respectively in the open position and in the closed position.

FIG. 3 shows a fluidic component using the device according to the invention to control fluidic access to a reaction chamber of the component.

FIG. 4 shows an advantageous embodiment of the heating module used in the fluidic valve type device of the invention.

### DETAILED DESCRIPTION OF AT LEAST ONE EMBODIMENT

In the remainder of the description, the terms “upstream” and “downstream” are to be understood with regard to the direction in which the fluid circulates in the fluidic circuit concerned.

In the remainder of the description, in a fluidic valve mechanism, a valve in the open state allows the fluid to pass (state 1 or ON) and a valve in the closed state blocks the passage of the fluid (state 0 or OFF).

The invention is notably aimed at a fluidic valve mechanism 33 incorporated into a fluidic component 1.

It should be noted that the fluidic valve mechanism 33 of the invention has reversible operation, insofar as it can be actuated from its first position to its second position and from its second position to its first position ad infinitum (within its mechanical limits).

The fluidic component 1 may notably be used for an analysis that requires heating.

The fluidic component 1 may take the form of a single one-piece element. This element may be produced by superposing several layers. The component 1 advantageously incorporates the entire fluidic part of the device.

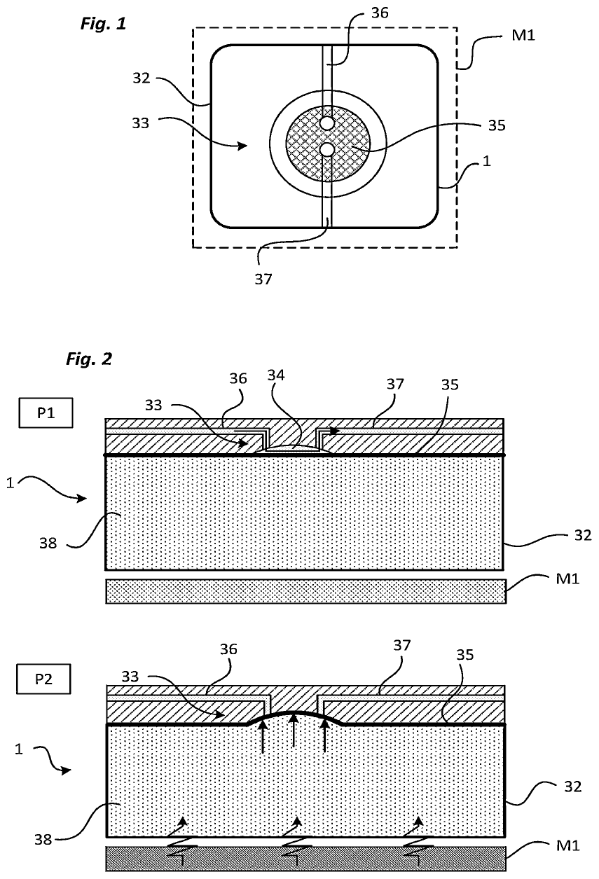

With reference to FIG. 1, the fluidic valve mechanism 33 is intended to be arranged on a fluidic circuit produced in the component 1 to control the passage of a fluid F in this fluidic circuit. In simplified terms, the fluidic valve mechanism 33 is arranged between an inlet channel 36 and an outlet channel 37 of the fluidic circuit.

The fluidic valve mechanism 33 comprises at least one fluidtight reservoir 32 intended to contain a volume of gas, advantageously a volume of air 38.

The fluidic valve mechanism 33 comprises a space 34 into which the inlet channel 36 opens and from which the outlet channel 37 emerges, the volume of the space 34 being variable according to the position of a deformable membrane 35 of the mechanism.

The membrane 35 is able to deform between an open first position in which the space 34 forms a passage for the fluid F between the inlet channel 36 and the outlet channel 37 of the controlled fluidic circuit (FIGS. 2—P1) and a closure position in which it blocks the passage of the fluid F in the controlled fluidic circuit (FIGS. 2—P2). In its closure position P2, the volume of the space 34 is thus zero or near-zero, the membrane 35 being pressed intimately against a surface of an upper substrate, onto which surface the two channels open. Depending on its position, the membrane 35 is therefore able to modulate the volume of the space 34 of the fluidic valve mechanism 33.

In order to move the membrane 35 of the mechanism between its first position and its second position, the device comprises a heating module M1. The heating module M1 is designed and configured to heat the volume of air 38 placed in the reservoir 32 in order to cause this volume of air to expand. By expanding in the reservoir 32, the air pushes on the membrane 35, thus deforming it toward its closure second position (P2). The membrane 35 then obstructs the inlet of the two channels 36, 37 in order to close the fluidic circuit by applying a pressure.

It should be noted that the reservoir 32 is closed in a fluidtight manner in the component.

The heating module M1 advantageously incorporates an electrical power supply and employs a control module M2.

It should also be noted that the heating module M1 may be incorporated into a support onto which said fluidic component 1 fits, so that the component 1 comes in the form of an easily replaceable consumable that is removable relative to the support. The support is then an assembly mechanically distinct from the component 1.

In a variant, the heating module M1 may be at least partially incorporated into said element forming the component 1. In the latter instance, by way of example, a resistance may be incorporated into the body of the component 1, said component 1 then fitting onto a support in order to connect said resistance to an external electrical power supply.

The control module M2 is configured to control the heating module M1 with a view to adjusting and regulating the applied temperature.

According to one particular aspect of the invention, it is possible to create an entirely stand-alone marker, it being possible for the heating module M1 to be external, or incorporated into the component or assembled therewith, the same being true of the control module M2.

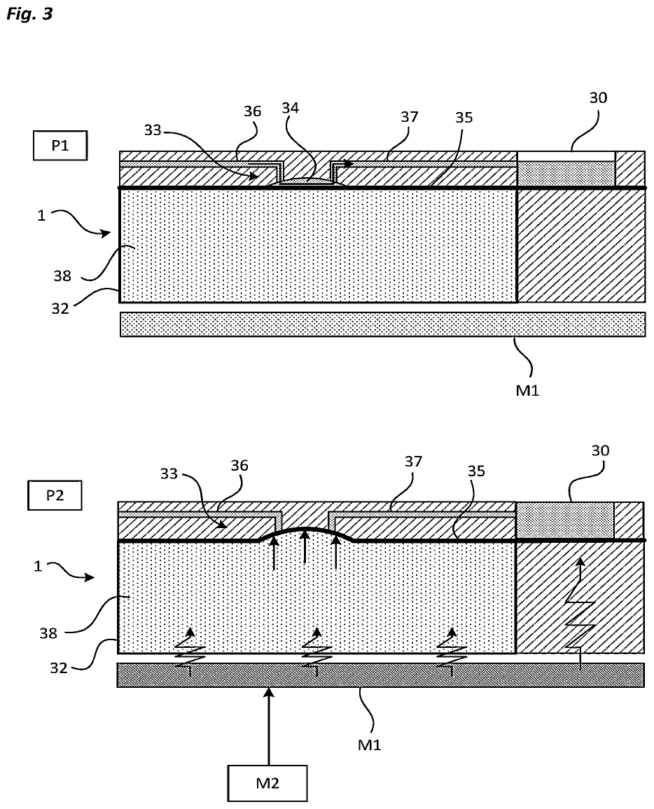

With reference to FIG. 3, the component 1 may notably be used to implement a detection reaction that requires heating of a reaction chamber 30.

The fluidic circuit may notably open, via the outlet channel 37, into said reaction chamber 30 so as to be able to supply same with fluid F.

Under certain conditions, it is necessary to isolate the reaction chamber 30, notably when the latter is heated so as to prevent the liquid present in the microfluidic chamber from evaporating.

Advantageously, the activation of the heating module M1, which is needed for implementing the chemical or biochemical detection reaction in the reaction chamber 30, is thus used to also actuate the membrane 35 of the fluidic valve mechanism 33 toward its closure position and thus isolate the chamber 30 by closing the fluidic circuit. In other words, a single command of the heating module M1 achieves both hot isolation of the reaction chamber 30 using the fluidic valve mechanism 33, and implementation of the chemical or biochemical detection reaction in the chamber 30.

In more concrete terms, the principle of operation of the device is as follows:
At low temperature, the chamber 30 and the fluidic circuit are at similar pressures. The membrane 35 is in its open position (P1), and the fluid can thus pass freely.
When the heating module M1 is activated, the air contained inside the reservoir 32 expands. If the deformation of the membrane 35 leads to a very small variation in the volume of fluid 38, to a first approximation, the increase in pressure is directly proportional to the rise in temperature (in K). Thus, in passing from 25° C. to 65° C. (298K to 338K), the pressure increases by 13% (around 100 mbar), which deforms the membrane 35 of the fluidic valve mechanism 33.
The deformed membrane 35 therefore blocks the two channels of the fluidic circuit, isolating the reaction chamber 30 from the outside (P2).

The degree of deformation of the membrane 35 is dependent on the material used and on its geometric characteristics such as the thickness and surface area thereof.

One very attractive advantage of this device is that it compensates for any potential expansion of the air bubbles that might be present in the reaction chamber 30. Specifically, to a first approximation, a bubble in the reaction chamber 30 will experience the same increase in pressure as the membrane 35 because it will also experience the same increase in temperature. With such a device, the size of the bubble in the chamber will therefore not be able to vary significantly during heating, and so will not interfere with any detection means that may have been installed for monitoring the progress of the reaction.

This device, by closing the fluidic circuit leading to the reaction chamber 30, also makes it possible to a large extent to limit evaporation. Thus, analyses lasting thirty minutes can be conducted with no appreciable loss of liquid.

When the temperature drops again, the pressures between the reservoir 32 and the fluidic circuits equalize and the membrane 35 returns to its original open position (P1).

Nonlimitingly, the membrane 35 is able to deform elastically between its two positions. By way of example, it may experience a deformation of more than 100% with respect to its initial shape.

By way of example, the membrane may notably be made from materials such as elastomers from the family of silicones such as MQ (Methyl-Polysiloxanes), VMQ (Vinyl-Methyl-Polysiloxanes), PVMQ (Phenyl-Vinyl-Methyl-Polysiloxanes) or elastomers of thermoplastic elastomer (TPE) type, for example TPE-S, TPS, TPE-E, TPC.

The reaction chamber 30 is advantageously produced in the component 1. This reaction chamber 30 may hold at least some of the reagents needed for implementing the reaction. These reagents may, for example, have been dried in the chamber or freeze-dried.

Nonlimitingly, the detection reaction performed in the chamber may be of biomolecular amplification type (PCR, LAMP . . . ) or may be of immuno-enzymatic type (ELISA type).

By way of example, for LAMP biomolecular amplification performed at 65° C. +/−1° C., the elastomer membrane may be produced using Ecoflex with the following geometric characteristics for isolating the reaction chamber 30: a thickness less than 0.2 mm and a diameter of between 2 and 3 mm.

It should be noted that analysis employing biomolecular amplification of microorganisms generally assumes the extraction of the genomic material of the microorganisms. Various technical solutions may of course be employed in order to do that. One attractive and advantageous solution is to perform thermal lysis on the microorganisms in the chamber 30. If the reagents needed for the biomolecular amplification are present in the chamber 30 then it is possible, using the same heating module M1, to close the valve 33 that then isolates the chamber 30 from the external surroundings and prevents the liquid from evaporating, to perform the thermal lysis of the microorganisms and to obtain the biomolecular amplification of the extracted DNA or RNA.

The component may incorporate several fluidic circuits, all leading to the same reaction chamber 30. It may for example additionally comprise a vented fluidic circuit, the vent sometimes being needed for filling the reaction chamber 30 with fluid. In order to isolate the chamber during the reaction, this second fluidic circuit will also need to be closed. To do that, use may be made of a fluidic valve mechanism 33 identical to the one described hereinabove. Advantageously, it is then possible to use just one single reservoir 32 that is common to a plurality of mechanisms. The heating module M1 may also be common to all the mechanisms operating in accordance with the principle of the invention. In this context, the heating module M1 is thus intended to heat:
The reaction chamber 30;
The volume of air 38 used for actuating the valve 33.

While at the same time retaining just one heating module M1, it may be beneficial to allow the valve 33 to close before the temperature needed for the reaction in the chamber 30 has been attained, the purpose for this being to avoid any contamination of the surroundings (by accidental spillage of the component) and prevent the solution present in the reaction chamber 30 from starting to evaporate while the temperature is increasing.

It is possible, with the one same heating source, to optimize the operation by altering the distribution of energy dissipation.

This then involves splitting the heating module into two resistive branches arranged in parallel or in series.

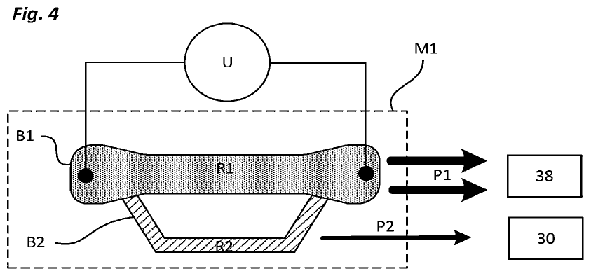

FIG. 4 illustrates this principle of splitting the heating module M1 into two resistive branches in parallel.

The two branches B1, B2 form two distinct resistances connected in parallel with a power supply U. If the material and thickness of each branch are the same, which is simpler in terms of manufacture, their width varies, making it possible to obtain two distinct resistances (the wider the track the lower the resistance). The current in the first branch can be expressed as I₁=IxR₂/(R₁+R₂) where:
I is the current injected into the setup;
I₁ is the current passing through the first branch;
R₁ is the resistance of the first branch;
R₂ is the resistance of the second branch.

The power dissipated (through Joule-heating effect) in the first branch B1 can be expressed as P₁=UxI₁=UxR2/(R₁+R₂) where U is the voltage supplied by the control module M2. If the resistance R₁ is different from the resistance R₂ this power is different for the two branches and therefore the heating powers of the two branches of the heating means M1 are different.

By altering the resistance values, it is therefore possible to obtain more thermal power in one branch than in the other. For the same materials and material thicknesses, it is possible to increase the power dissipated in the widest branch, as shown in FIG. 4. FIG. 4 shows that the thermal power P1 emitted by the first branch B1 is higher than that (P2) emitted by the second branch B2 of the module. The temperature needed to activate the valve 33 in order to seal off the chamber 30 is thus attained more rapidly than the temperature needed for the reaction in the reaction chamber 30.

The same principle may be applied to two resistive branches in series.

This principle may of course be adapted to suit several branches in series, in parallel, or even in series/parallel, in each case by altering the width of each track.

It is particularly advantageous to produce the heating module M1 on a thin film by deposition (sputtering, screen printing, stenciling). It is thus possible to align the various branches precisely with the elements of the component to be heated and to choose the thermal power dissipated in each of the branches.

The device may also comprise a control module M2 configured to control the heating module M1 with a view to adjusting and regulating the applied temperature, it being possible for this control module M2 to be incorporated into the heating module.

The heating module M1 advantageously forms part of an instrument/support onto which the component 1 may be fitted.

Likewise, the control module M1 advantageously forms part of the above-mentioned instrument.

In order to create an entirely stand-alone marker, the heating module M1 may, however, be at least partially incorporated into the component or assembled therewith, the same being true of the control module M2. In that case, the device will need to comprise an electrical power supply such as an integrated battery.

The solution of the invention can be differentiated from the earlier solutions through the fact that it is based solely on polymer materials, that it avoids recourse to chemical products for producing a gas inside the fluidic component, that it avoids pneumatic connections between the fluidic component and an instrument and does not use external pneumatic solutions in order to operate. The heating module may also be fully incorporated into the component, thus making it possible to obtain a fully stand-alone and readily transportable device.

1. A fluidic component intended to be associated with a heating module and wherein a fluidic circuit comprises an inlet channel and an outlet channel, said fluidic component comprising:
a fluidic valve mechanism comprising:
a fluidtight reservoir intended to be filled with a volume of gas capable of expanding,
a deformable membrane closing said reservoir in a fluidtight manner, said membrane being able to deform by expansion of said volume of gas, between a first position in which it forms a passage between said inlet channel and said outlet channel so as to allow a fluid to pass, and a second position in which it obstructs said passage.

2. The component according to claim 1, comprising at least a first substrate wherein said inlet channel and said outlet channel are produced, and a second substrate into which there is hollowed a cavity forming said reservoir, facing the inlet channel and the outlet channel, said membrane being interposed between the first substrate and said second substrate in order to cover said cavity.

3. The component according to claim 1, wherein the membrane is produced from a material of elastomer type.

4. The component according to claim 1, wherein said component is produced in the form of a one-piece element incorporating said fluidic circuit and said fluidic valve mechanism.

5. A device of fluidic valve type, comprising:
a fluidic component as defined in claim 1,
a heating module designed to heat said volume of gas contained in said reservoir and commanded to heat it to a temperature sufficient to expand said volume of gas present in the reservoir, causing the membrane to deform from its first position toward its second position.

6. The device according to claim 5, wherein said component is produced in the form of a one-piece element able to fit onto a support including said heating module.

7. The device according to claim 5, wherein said component is produced in the form of a one-piece element and wherein the heating module is incorporated into said one-piece element.

8. The device according to claim 5, wherein the fluidic circuit comprises a reaction chamber, and wherein said fluidic valve mechanism is arranged on the fluidic circuit opening into said reaction chamber, the heating module being designed to heat both:
said reaction chamber in order to perform a detection reaction, and
the reservoir of said fluidic valve mechanism so as to expand the volume of gas, causing the membrane to move toward its closure position with a view to isolating the chamber during said reaction.

9. The device according to claim 8, wherein the heating module comprises at least two resistive branches in parallel, each one configured to exhibit a distinct electrical resistance, the first branch being dedicated to providing a first thermal power and the second branch dedicated to providing a second thermal power, said first thermal power being higher than the second thermal power.

10. The device according to claim 8, wherein the heating module comprises at least two resistive branches in series, each one configured to exhibit a distinct electrical resistance, the first branch being dedicated to providing a first thermal power and the second branch dedicated to providing a second thermal power distinct from the first thermal power.

11. An analysis method implemented in a device as defined in claim 8, said method comprising activating the heating module to a temperature sufficient to both implement a detection reaction in said reaction chamber and actuate the membrane toward its closure position so as to isolate the reaction chamber during said detection reaction.
